(19) United States
(12) Patent Application Publication
(10) Pub. No.: US 2010/0009093 A1
(43) Pub. Date: Jan. 14, 2010

(54) THERMAL SPRAY FORMATION OF POLYMER COATINGS

(76) Inventors: Coguill L. Scott, Butte, MT (US); Stephen L. Galbraith, Butte, MT (US); Darren L. Tuss, Belgrade, MT (US); Milan Ivosevic, Butte, MT (US); Lawrence C. Farrar, Butte, MT (US)

Correspondence Address: ROBERT M. HUNTER PLLC, P.O. BOX 2709, KAMUELA, HI, 96743, US

(21) Appl. No.: 12/311,405

(22) PCT Filed: Apr. 11, 2007
(86) PCT No.: PCT/US07/09021

§ 371 Date: Mar. 26, 2009

(51) Int. Cl. B05D 1/12; B05B 1/24; B05B 7/16

(52) U.S. Cl. 427/457; 427/185; 118/58

(57) ABSTRACT

A system (30) and method for fluidizing a polymer powder (11) to be sprayed, metering the material (12) and mixing it with a heated carrier-gas stream (13) to produce a spray (32), and using the spray (32) to transport the material (12) to a substrate (34) and radiant an convective heating of the material (12) during transport to achieve melting of the polymer powders (11).

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. NAS3-02164 awarded by the National Aeronautics and Space Administration.

### CROSS-REFERENCE TO RELATED APPLICATIONS

Not Applicable

### INCORPORATION-BY-REFERENCE OF MATERIAL SUBMITTED ON A COMPACT DISC

Not Applicable

### BACKGROUND OF THE INVENTION

This invention relates to the formation of polymer coatings. In particular, the invention relates to the use of a thermal spray apparatus and polymer powders to create sprayable polymer coatings.

The background art is characterized by U.S. Pat. Nos. 3,677,471; 3,958,758; 4,065,057; 4,835,022; 4,911,956; 5,041,713; 5,285,967; 5,718,863; 6,074,194; 6,488,773 and 6,793,976; and by U.S. Patent Application No. 2002/0110682; the disclosures of which patents and patent application are incorporated by reference as if fully set forth herein.

Background art methods for polymer thermal spraying utilize the traditional thermal spray techniques developed to create metal and ceramic coatings. These methods rely on high temperature sources such as plasma arcs and combustion flames. Some background art methods essentially call for the spraying of pre-melted molten thermoplastics. Others call for plasma spraying of polymers. Yet others call for combustion flame spraying of polymers, while others call for High Velocity Oxy Fuel (HVOF) combustion spraying of polymer coatings. Others call for use of resistive element heating for thermal spraying of polymers.

Background art methods and systems for applying polymer film coatings have serious limitations. Solvent spray methods often release toxic (volatile organic compounds, VOC's) to the environment. Background art thermal spray methods which rely on hot combustion gas (greater than 1,500° C.) or hot plasma gas (greater than 10,000° C.) can result in overheating of polymer particles in flight and also can cause overheating of polymer layers deposited in previous spray passes. Excessive heating of polymers by these processes can cause oxidation and/or thermal degradation of the sprayed material resulting in inferior properties and shorter service life. The methods that rely on combustion gases are inherently less clean due to the exhaust fumes. This invention is advantageous because the polymer powder mixes with the hot gas outside of the spray apparatus and eliminates the possibility of fouling the apparatus with molten polymer adhered to the apparatus nozzle.

What is needed is a polymer thermal spray apparatus and method utilizing resistive element heating as a heat source for main spray gas. Moreover, the apparatus must not be prone to material fouling problems that result from the way in which the polymer materials are introduced into the thermal spray process.

### BRIEF SUMMARY OF THE INVENTION

A purpose of the invention is to provide means for spray forming of polymer coatings on a variety of substrates using eclectically heated gas stream. Another purpose is to enable use of a dray polymer powder without solvent dilution. Another purpose is to provide means for melting the polymer onto the surface of the substrate during the spray process. Another purpose is to prevent exposure of the polymer materials to temperatures in excess of their degradation temperatures. Another purpose is to avoid the use of thermal spray methods utilizing plasma or flame that can cause polymer overheating and degradation.

The invention is advantageous in that it allows for the formation of spray-in-place polymer coatings comprising thermoplastic or thermoset polymers. Background art methods employed to create film coatings required solvent-dissolved polymer to be sprayed onto a substrate with a drying time needed for the solvent to evaporate, or to be electrostatically sprayed onto a substrate and the entire substrate placed in an oven to cure/fuse, or polymer powders to be thermally sprayed with a high temperature flame or plasma. This invention and method does not require solvents, oven baking, combustion flames/jets or plasma arcs.

In a preferred embodiment, the invention is a device using powdered precursor polymer material and converts it into fully or partially molten polymer particles and then propels them toward the substrate to be coated. In a preferred embodiment, the invention is a method for directly converting a powdered polymer into polymer coating onto a substrate using a field deployable system. In a preferred embodiment, the invention is configured to spray polymer powder to form an adherent, mechanically-sound, thickness-regulated film. In a preferred embodiment, the invention uses both radiation and convection to process the polymer materials while spray forming the film. In a preferred embodiment, the invention is a fully-contained, field-deployable apparatus that includes power distribution, heater controls, polymer constituent material bins, flow controls, material transportation functions and a thermal spray apparatus. In this embodiment, operation requires only a power source.

In preferred embodiments, the method and system involve fluidizing a material to be sprayed, metering the material into and mixing it with a heated carrier-gas stream, and using the spray to transport the material to a substrate and radiant and convective heating of the material during transport to achieve melting of the polymer film constituent powder particles.

In a preferred embodiment, the thermal spray apparatus comprises an electrical resistive element heater that heats an air flow. The air flow follows a serpentine path from an inlet at one end of the heater to the nozzle outlet at the end of the heater pointed at a substrate to be coated. The serpentine path maintains a close-to-ambient temperature for the exterior of the heater while allowing the flowing gas to be heated to approximately the temperature of the heater element. After exiting the spray nozzle, polymer powder is injected into the hot gas stream where it melts during the flight to the substrate. In this embodiment, the material transport subsystem of the thermal spray system terminates with a set of polymer powder injection nozzles located on the thermal spray apparatus. Powder particles preferably reach the nozzles via a series of distribution tubes that originate at the material supply hopper located in a utility cart.

In more preferred embodiments, invention involves the convective heating of a thermoplastic polymer powder after it is injected into a hot gas stream. A hot gas stream with a temperature range of about 100° C. to about 800° C. is preferably used to simultaneously melt/soften and accelerate the polymer materials. The resulting molten droplets/particles are preferably accelerated in a gas stream to velocities of about 1 m/s to greater than 100 m/s and propelled towards the surface to be coated. In these embodiments, upon impact at the surface of the targeted material, the heated particles deform (splat), consolidate and cool (solidify) to form a coating or a deposit of material.

In a preferred embodiment, the apparatus is equipped with an ultraviolet light source (350-420 nanometer wave length) to enable the curing of ultraviolet-light-curable polymer powders as they are being deposited as molten films. Ultraviolet (UV) light has limited penetration, especially of dark tinted polymers. This embodiment allows UV light exposure, complete penetration of the thin molten film and subsequent cure during each pass of the apparatus. This removes limitations on film thickness typically associated with UV-light-curable polymers. In another preferred embodiment, the apparatus is equipped with an infrared light source to aid in the curing of thermoset polymer powders as they are being deposited as molten films.

A preferred process for hot gas spraying of polymer powder has the following characteristics: A gas flow stream is heated by an electro-resistant in-line heater and directed out of a nozzle into the environment. The hot gas stream has higher temperature at nozzle exit and lower further down the gas stream as it flows away from the nozzle, with the gas temperature at the nozzle exit is preferably in the range of about 100° C. to about 800° C. The gas temperature at the substrate surface may be adjusted within temperature range of about 50° C. to about 500° C. by varying spray distance, gas flow rate and/or initial temperature at the nozzle exit. The gas temperature at the substrate surface is preferably adjusted to be above the melting temperature of sprayed polymer. The temperature of the sprayed particles at impact with the substrate may be higher then temperature of the gas at substrate surface due to higher thermal inertia of the particles relative to process gas.

In preferred embodiments, careful design consideration is given to the gas velocity at the nozzle exit and gas velocity/temperature as the polymer particle laden plume impinges upon the substrate being coated. When the polymer particles are initially injected into the hot gas plume there exist a high relative velocity difference between the fast moving gas and the relatively slow moving polymer particles. This creates a condition of high convective heat transfer between the hot gas and the lower temperature particles. This condition allows the polymer particles to quickly heat and soften/melt. As the particle accelerates to match the velocity of the hot gas, the heat transfer condition becomes less favorable. Additionally, the hot gas plume temperature decreases as the plume expands and entrains ambient air. Consequently, the polymer particles, now in the form of molten or softened droplets, do not cool as fast as they heated and can retain their temperature as they impact the substrate. At this point, the gas plume that strikes the substrate is cooler then the molten polymer particles being conveyed. This allows heat sensitive substrates to be coated even when the molten polymer has a temperature in excess of the upper allowed substrate temperature. On the other hand, larger partially molten particles that stick to the substrate can be heated to a higher temperature by hot convective gas and successfully fused/consolidated with rest of coating on the substrate. The preferred particle size distribution of powder that is sprayed using this device is in the range of about 30 microns to about 300 microns.

One of the advantageous features of preferred embodiments of the process is low heat input to the substrate due to negligible thermal mass (about 10-60 Jules per particle) of the micron sized droplets. This feature allows the deposition of high melting temperature polymers (greater than 200° C.) and low melting temperature metals (less than 600° C.) over heat sensitive substrates such as electronics and even paper without damaging the underlying substrate surface.

In a preferred embodiment, the invention is a process for forming a polymer coating on a target substrate, said process comprising: heating a gas flow stream using an electro-resistant in-line heater to a temperature in the range of about 100° C. to about 900° C. and projecting said gas flow stream out of a converging nozzle toward the target substrate; transporting a powdered material from a fluidized bed powder hopper through a manifold to at least one pair of opposed material injectors that are operative to propel said powdered material into said gas flow stream; melting said powdered material within said gas flow stream to produce a plurality of melted material droplets; and directing said plurality of melted material droplets onto the substrate. Preferably, said powdered material comprises a plurality of thermoplastic polymer particles, a plurality of thermoset polymer particles, or a plurality of ultraviolet-light curable polymer particles having a particle size in the range of about 30 microns to about 500 microns. Preferably, said gas flow stream is shaped by said converging nozzle so as to produce a convective heat transfer region within which said melting step is accomplished. Preferably, said gas flow stream has a longitudinal axis and said at least one pair of opposed material injectors propel said powdered material into said gas flow stream at substantially a right angle to said longitudinal axis. In a preferred embodiment, the process further comprises: tribocharging or enhancing the positive charge of said powdered material before it is propelled into said gas flow stream. In another preferred embodiment, the process further comprises: using a laser distance gage to establish and maintain a desired distance between said material injectors and the substrate. Preferably, said melted material droplets are comprised of a molten ultraviolet-light curable polymer and said process further comprises: using an ultraviolet light source with a curing-initiating emission wavelength to initiate curing of said molten ultraviolet-light curable polymer on the substrate. Preferably, said melted material droplets are comprised of a molten thermosetting polymer and said process further comprises: using an infrared heat lamp to generate a substrate surface temperature that assists in curing of said molten thermosetting polymer on the substrate.

In another preferred embodiment, the invention is a process for forming a polymer coating on a substrate, said process comprising: fluidizing a material to be sprayed; heating a carrier-gas stream by flowing it along a serpentine path through a heater to produce a heated carrier-gas stream; discharging said heated carrier-gas stream from a nozzle; metering said fluidized material into and mixing it with said heated carrier-gas stream downstream of said nozzle to produce a spray; using the spray to transport said material to the substrate and convective heating of the material by the heated carrier-gas stream during transport to achieve melting of said material to produce a molten material; depositing said molten material on the substrate; and cooling said molten material to produce a coating. Preferably, said metering step is accomplished by discharging said fluidized material through opposed polymer powder injection nozzles. Preferably, said material is a thermoplastic polymer, a thermoset polymer, or an ultraviolet-light-curable polymer. Preferably, said hot gas stream has a temperature in the range of about 100° C. to about 900° C. Preferably, said molten material is accelerated to a velocity in the range of about 0.1 meter per second to greater than 100 meters per second.

In yet another preferred embodiment, the invention is a process for thermal spray formation of a polymer coating on a substrate, said process comprising: directing a hot gas stream at the substrate with an apparatus; combining a polymer powder stream with said hot gas stream outside of said apparatus to produce a combination, said combination having a temperature and a velocity that are operative to prevent degradation and ignition of said polymer powder stream; and depositing said combination on the substrate to produce the polymer coating; wherein said combining step occurs after said hot gas stream has been launched toward the substrate, thereby preventing fouling of said apparatus. Preferably, the process further comprises: tribocharging or enhancing the positive charge of said polymer powdered stream before it is combined with said gas flow stream. Preferably, the process further comprises: using a laser distance gage to establish and maintain a desired distance between said apparatus and the substrate.

In a further preferred embodiment, the invention is a process for forming a polymer coating on a substrate target, said process comprising: directing a hot air stream having a longitudinal axis at the substrate target; introducing at least two polymer powder streams comprising a polymer powder into said hot air stream to produce a spray, one of said polymer powder streams having a first direction that is substantially normal to said longitudinal axis and another of said polymer powder streams having a second direction that is substantially opposite said first direction; melting said polymer powder within said hot air stream; and depositing said spray on the substrate to produce the polymer coating.

In another preferred embodiment, the invention is a process for forming a polymer coating on a target substrate, said process comprising: a step for heating a gas flow stream using an electro-resistant in-line heater to a temperature in the range of about 100° C. to about 800° C. and projecting said gas flow stream out of a converging nozzle toward the target substrate; a step for transporting a powdered material from a fluidized bed powder hopper through a manifold to at least one pair of opposed material injectors that are operative to propel said powdered material into said gas flow stream; a step for melting said powdered material within said gas flow stream to produce a plurality of melted material droplets; and a step for directing said plurality of melted material droplets onto the substrate.

In yet another preferred embodiment, the invention is a process for forming a polymer coating on a substrate, said process comprising: a step for fluidizing a material to be sprayed; a step for heating a carrier-gas stream by flowing it along a serpentine path through a heater to produce a heated carrier-gas stream; a step for discharging said heated carrier-gas stream from a nozzle; a step for metering said fluidized material into and mixing it with said heated carrier-gas stream downstream of said nozzle to produce a spray; a step for using the spray to transport said material to the substrate and convective heating of the material by the heated carrier-gas stream during transport to achieve melting of said material to produce a molten material; a step for depositing said molten material on the substrate; and a step for cooling said molten material to produce a coating.

In another preferred embodiment, the invention is a system for forming a polymer coating on a target substrate, said system comprising: means for heating a gas flow stream using an electro-resistant in-line heater to a temperature in the range of about 100° C. to about 800° C. and projecting said gas flow stream out of a converging nozzle toward the target substrate; means for transporting a powdered material from a fluidized bed powder hopper through a manifold to at least one pair of opposed material injectors that are operative to propel said powdered material into said gas flow stream; means for melting said powdered material within said gas flow stream to produce a plurality of melted material droplets; and means for directing said plurality of melted material droplets onto the substrate.

In yet another preferred embodiment, the invention is a system for forming a polymer coating on a substrate, said system comprising: means for fluidizing a material to be sprayed; means for heating a carrier-gas stream by flowing it along a serpentine path through a heater to produce a heated carrier-gas stream; means for discharging said heated carrier-gas stream from a nozzle; means for metering said fluidized material into and mixing it with said heated carrier-gas stream downstream of said nozzle to produce a spray; means for transporting said material to the substrate and convective heating of the material by the heated carrier-gas stream during transport to achieve melting of said material to produce a molten material.

In another preferred embodiment, the invention is a system for applying a polymer coating to a substrate, said system comprising: a support cart that comprises a blower, a polymer powder storage hopper and a polymer powder pump having a pump outlet and a pump inlet that is in fluid communication with said polymer powder storage hopper; an applicator head that comprises an air heater, a nozzle having a nozzle inlet that is connected to said heater and a nozzle outlet, a manifold and a plurality of injectors that are connected to said manifold; and an umbilical assembly that comprises an air supply hose that connects said blower to said air heater so that said air heater is in fluid communication with said blower and a tube that connects said pump outlet to said manifold so that said manifold is in fluid communication with said pump outlet; wherein said injectors are disposed adjacent to and outside of said nozzle outlet. Preferably, said support cart further comprises a service panel that contains system controls. Preferably, said umbilical assembly further comprises wires that connect said applicator head with said service panel in said support cart. Preferably, said applicator head further comprises a handle having a trigger that is operative to switch said polymer powder pump on and off. Preferably, said applicator head further comprises a thermocouple that is operative to sense the temperature within said nozzle. Preferably, said applicator head further comprises a main material transport tube that is connected to said tube, two primary branch tubes that are connected to said main material transport tube, and two pair of secondary branch tubes, each pair of which is connected to a secondary branch tube. Preferably, said applicator head further comprises a laser distance gage that is operable to provide a visual clue to the operator of the system when a desired distance between said applicator head and the substrate is established and maintained. Preferably, said applicator head further comprises a laser distance gage that is operable to provide a visual clue to the operator of the system when a desired distance between said applicator head and the substrate is established and maintained. Preferably, said applicator head further comprises an ultraviolet-light source that is adapted to provide curative energy of a wavelength that is operative to cure an ultraviolet-light curable polymer powder. Preferably, said applicator head further comprises an infrared heat lamp that is adapted to provide substrate surface heating, thereby achieving a substrate surface temperature that is desirable for curing of a thermosetting polymer powder.

In yet another preferred embodiment, the invention is a process for heating a polymer particle as it moves toward a target, said process comprising: imparting a particle velocity and a particle temperature to the polymer particle; introducing the polymer particle to a gas stream that is moving through ambient air toward the target, said gas stream having a gas stream velocity that is greater than said particle velocity to produce a velocity difference and said gas stream having a gas stream temperature that is greater than said particle temperature to produce a temperature difference, thereby achieving a heat transfer rate; transferring heat to the polymer particle at said heat transfer rate, thereby increasing said particle temperature; increasing said particle velocity, thereby decreasing said velocity difference and decreasing said heat transfer rate; and entraining a portion of said ambient air into said gas stream, thereby decreasing said gas stream temperature; thereby producing a heated polymer particle that is being carried by a cooled gas stream.

In another preferred embodiment, the invention is a system for heating a polymer particle as it moves toward a target, said system comprising: means for imparting a particle velocity and a particle temperature to the polymer particle; means for introducing the polymer particle to a gas stream that is moving through ambient air toward the target, said gas stream having a gas stream velocity that is greater than said particle velocity that is operative to produce a velocity difference and said gas stream having a gas stream temperature that is greater than said particle temperature that is operative to produce a temperature difference, said means for introducing thereby being operative to achieve a heat transfer rate; means for transferring heat to the polymer particle at said heat transfer rate, said means for transferring heat thereby being operative to increase said particle temperature; means for increasing said particle velocity, said means for increasing thereby being operative to decrease said velocity difference and decrease said heat transfer rate; and means for entraining a portion of said ambient air into said gas stream, said means for entraining thereby being operative to decrease said gas stream temperature; said system thereby being operative to produce a heated polymer particle that is carried by a cooled gas stream.

In a further preferred embodiment, the invention is a process for heating a polymer particle as it moves toward a target, said process comprising: imparting a particle velocity to the polymer particle, said polymer particle having a particle temperature; introducing the polymer to particle to a gas stream that is moving through ambient air toward the target, said gas stream having a gas stream velocity that is greater than said particle velocity to produce a velocity difference and said gas stream having a gas stream temperature that is greater than said particle temperature; transferring heat to the polymer particle at a heat transfer rate and increasing said particle temperature; increasing said particle velocity, decreasing said velocity difference and decreasing said heat transfer rate; and entraining a portion of said ambient air into said gas stream, decreasing said gas stream temperature, and producing a heated polymer particle that is being carried by a cooled gas stream.

In another preferred embodiment, the invention is a process for forming a polymer coating on a target substrate by heating a polymer particle as it moves toward the target, said process comprising: imparting a particle velocity to the polymer particle, said polymer particle having a particle temperature; introducing the polymer particle to a gas stream that is moving through ambient air toward the target, said gas stream having a gas stream velocity that is greater than said particle velocity and said gas stream having a gas stream temperature that is greater than said particle temperature; transferring heat to the polymer particle; increasing said particle velocity; and entraining a portion of said ambient air into said gas stream, decreasing said gas stream temperature, and producing a heated polymer particle that is being carried by a cooled gas stream to the target.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate presently preferred embodiments of the invention. In the drawings:

FIG. 1A is a schematic diagram depicting the key process characteristics of a preferred embodiment of the invention.

FIG. 1B is a schematic diagram depicting the key process characteristics of another preferred embodiment of the invention.

FIG. 1C is a schematic diagram depicting the key process characteristics of another preferred embodiment of the invention.

FIG. 2 is a perspective view of a preferred embodiment of the invention.

FIG. 3 is a perspective view of the thermal spray applicator portion of a preferred embodiment of the invention.

FIG. 4 is a perspective view of the powdered material distribution portion of the applicator of a preferred embodiment of the invention.

FIG. 5 is a cross-sectional schematic diagram of the material injection operation in accordance with a preferred embodiment of the invention.

FIG. 6 is a cross-sectional schematic diagram of the hot gas path within the applicator of a preferred embodiment of the invention.

FIG. 7 is a perspective view of the applicator support cart of a preferred embodiment of the invention.

FIG. 8 is a perspective view of the applicator head of another preferred embodiment of the invention.

The following reference numerals are used to indicate the parts and environment of the invention on the drawings:
1 umbilical assembly
2 applicator body
3 converging nozzle
4 tubular manifold, manifold
5 material injectors
6 trigger
7 shroud
8 main material transport tube, tube
9 primary branch tubes
10 secondary branch tubes
11 powdered material, polymer powder
12 impinging material
13 hot air jet
14 convective heat transfer region
15 air
16 serpentine path
17 heater element, convective heater
18 support cart, cart
19 regenerative blower
20 fluidized bed powder hopper and powder pump, fluidized bed hopper and pump
21 rotary compressor
22 service panel
23 electrical enclosure
25 handle
26 convective air hose
27 electrical cord and signal wire
28 thermocouple cable
29 powder conveying hose
30 polymer thermal spray system, system
32 spray stream
34 target substrate, substrate
36 applicator head
37 convective gas temperature
38 polymer powder particle surface temperature
39 polymer powder particle core temperature
40 deposited polymer material
42 additional radiation source
44 laser distance gage

### DETAILED DESCRIPTION OF THE INVENTION

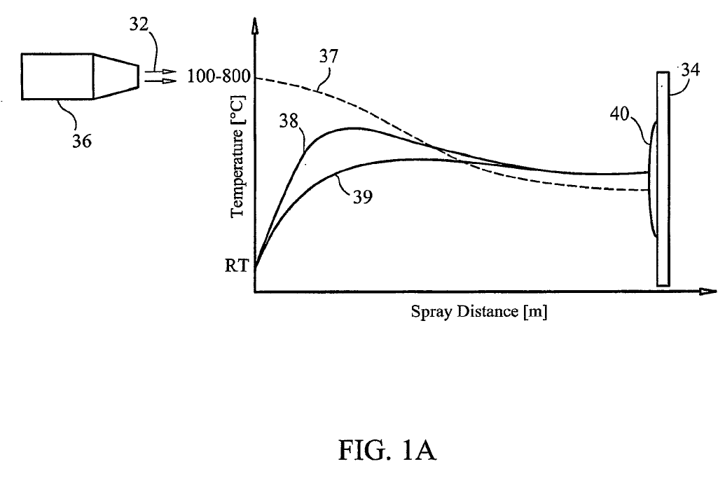

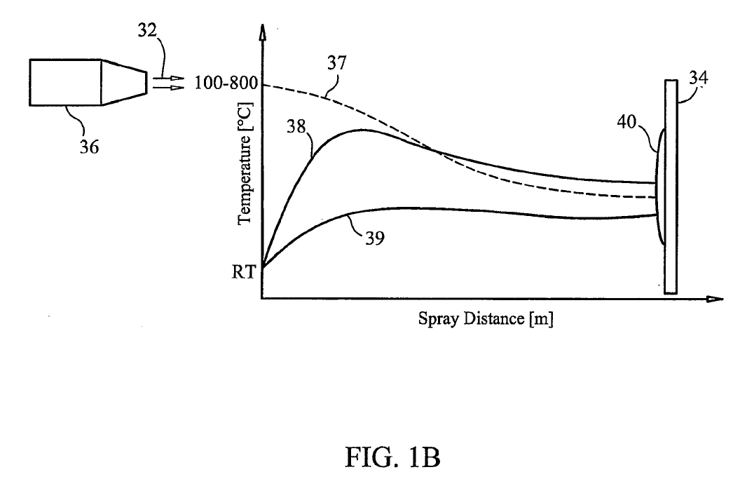

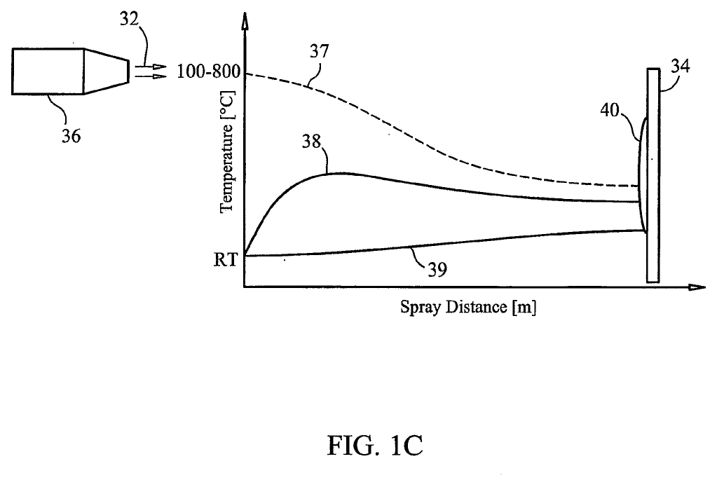

Referring to FIGS. 1A, 1B and 1C, schematic diagrams illustrating the operation of preferred embodiments of system 30 are presented. FIG. 1A illustrates changes in convective gas temperature 37, polymer powder particle surface temperature 38 and polymer powder particle core temperature 39 that occur with a polymer powder particle size of less than about 100 micrometers. FIG. 1B illustrates changes in convective gas temperature 37, polymer powder particle surface temperature 38 and polymer powder particle core temperature 39 that occur with polymer powder particle sizes that range from about 100 micrometers to about 300 micrometers. FIG. 1C illustrates changes in convective gas temperature 37, polymer powder particle surface temperature 38 and polymer powder particle core temperature 39 that occur with a polymer powder particle size of greater than about 300 micrometers.

In these diagrams, applicator head 36 discharges spray 32 comprised of hot air jet 13 and impinging material 12 which in turn comprises polymer powder 11. Initially, hot air jet 13 preferably has a relatively high temperature (e.g., 100-800° C.) and a high velocity (e.g., 10-200 meters per second, m/s) and the polymer powder 11 has a relatively low temperature (e.g., room temperature) and zero velocity as the impinging material 12 enters the hot air jet 13 at right angles to the direction of flow of hot air jet 13. The high temperature difference and high relative velocity difference between hot air jet 13 and the particles of polymer powder 11 create a favorable condition for heat transfer from hot air jet 13 to polymer powder 11. The outer surface of each particle of polymer powder 11 heats up to polymer powder temperature 38. The core of each particle of polymer powder 11 heats up conductively to polymer powder temperature 39.

The diameter of the particles of polymer powder 11 determines how quickly the core temperature 39 reaches the surface temperature 38 as shown in FIGS. 1A, 1B and 1C. As spray 32 travels towards substrate 34, gas temperature 37 decreases as cold air is entrained. The convective heat transfer conditions are less favorable near substrate 34 since the temperature difference and the velocity difference between hot air jet 13 and the particles of polymer powder 11 are much lower. This creates a lower convective heat transfer condition which prevents the particles of polymer powder 11 from cooling as fast as they heated. Polymer powder particle surface temperature 38 rapidly increases as heat is transferred from hot air jet 13 to polymer powder 11. Polymer powder particle core temperature 39 increases at a slower, more consistent, rate as heat is conducted from the particle surface to the particle core. At a spray distance sufficient to allow the polymer particle core temperature 39 to reach a molten state (e.g., 10-25 cm) a deposition of molten/softened material 40 is formed on substrate 34.

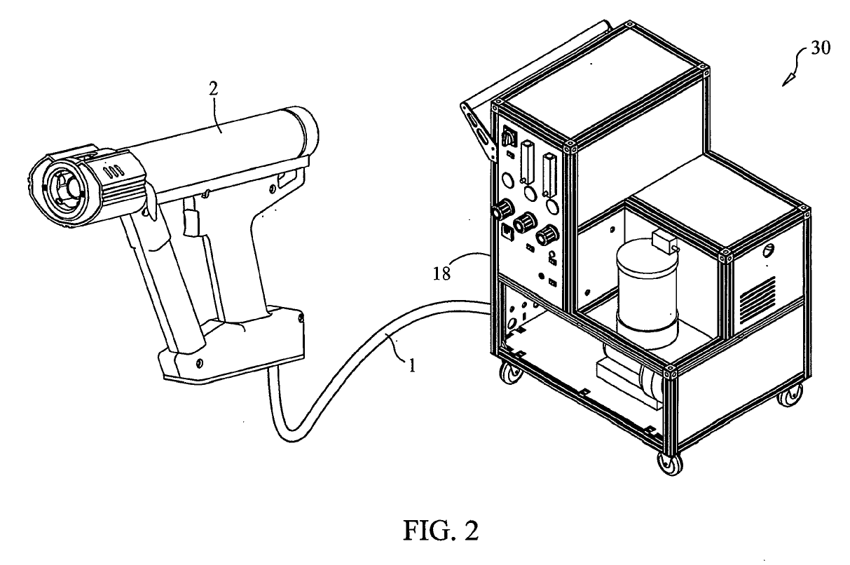

Referring to FIG. 2, the main components of the preferred embodiment of system 30 are presented. In this embodiment, system 30 comprises three primary elements: applicator head 36, umbilical assembly 1 and support cart 18. Umbilical assembly 1 preferably contains convective air hose 26, electrical cord 27, thermocouple connector 28, and powder conveying hose 29. Support cart 18 comprises fluidized bed powder hopper and powder pump 20 and service panel 22 which contains system controls.

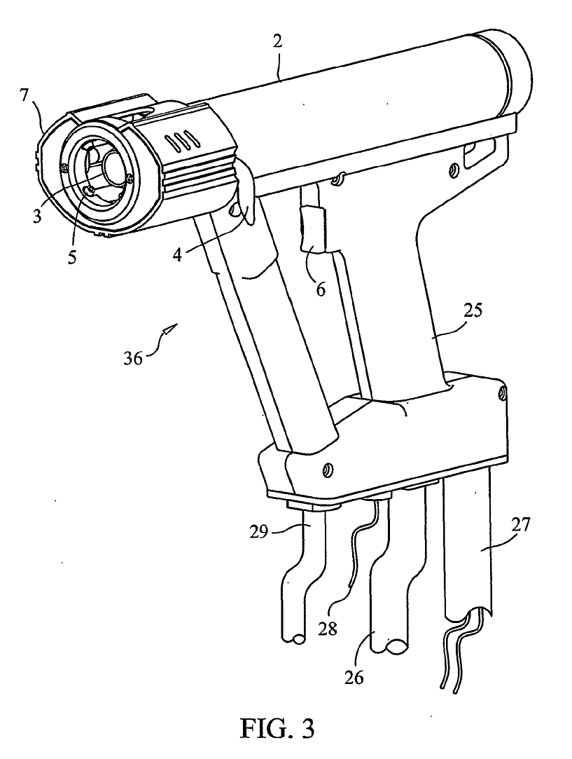

Referring to FIG. 3, a preferred embodiment of applicator head 36 of system 30 is illustrated. In this embodiment, a gas (preferably air) at ambient temperatures is conveyed through convective air hose 26 into applicator body 2 in which it is heated. Within applicator body 2 is a replaceable heater core (not shown). Power for the replaceable heater core passes through electrical cord 27 attached to handle 25. Applicator body 2 also functions as the heater housing in that air flow through the heater housing is drawn through the housing in a serpentine manner, thus keeping the outside of body 2 cool to the touch. In alternative embodiments, a gas other than air (e.g., an inert gas) is used.

As the gas (preferably air) flows thorough the heater core, the air is preferably heated to temperatures up to about 700° C. As the hot air exits through converging nozzle 3, converging nozzle 3 preferably shapes the hot air flow and projects the hot air toward target substrate 34. The shaped hot air flow deters entrainment of colder air from the surrounding environment in the hot air flow, thereby providing high temperature air at target substrate 34. Preferably, located within converging nozzle 3 is a thermocouple (not shown) that provides temperature feedback to a power supply and controller via thermocouple cable 28 attached to handle 25.

Powdered material 11 is preferably transported through tubular manifold 4 to material injectors 5. As material 11 exits the material injectors 5, it is propelled into the shaped hot air stream and material 11 becomes entrained in the center of the shaped hot air stream near converging nozzle 3. Once inside the hot air stream, powdered material 11 is melted by the hot air and projected onto the surface of substrate 34.

In a preferred embodiment, trigger 6 located on handle 25 of applicator head 36 allows the operator to start and stop the material flow through tubular manifold 4. The function of starting and stopping the material flow is that, when material flow is stopped, hot air from the converging nozzle 3 may be used to fuse the deposited molten material into a film on the substrate 34 without adding additional material. Shroud 7 protects tubular manifold assembly 4, converging nozzle 3 and material injectors 5 from damage during use of system 30.

Umbilical assembly 1 begins at support cart 18 and terminates at applicator head 36. Umbilical assembly 36 preferably comprises convective air hose 26 that extends from regenerative blower 19 in support cart 18 and transports air 15 to applicator body 2. In preferred embodiment, regenerative blower 19 is a single-stage high-flow air blower, Model 1010K1 from McMaster-Carr, Los Angeles, Calif. In addition, umbilical assembly 1 preferably comprises a powder conveying hose 29 to transport powdered material 11. This tube connects fluidized bed powder hopper and powder pump 20 in support cart 18 to main material transport tube 8 on applicator body. In a preferred embodiment, fluidized bed powder hopper and powder pump 20 is a Nordson 100 Plus powder pump with stainless steel fluidized hopper from Powder Parts, Inc., Elgin, Ill. Umbilical assembly 1 preferably also comprises electrical power wires 27 connecting heater elements 17 to the power source (not shown) in electrical enclosure 23. Umbilical assembly 1 preferably also comprises thermocouple feedback wire 28 that extends from convergent nozzle 3 to a temperature controller (not shown) in electrical enclosure 23. In this embodiment, umbilical assembly 1 also comprises a set of signal wires 27 that connect trigger 6 to the powder flow on/off control circuit (not shown) in electrical enclosure 23.

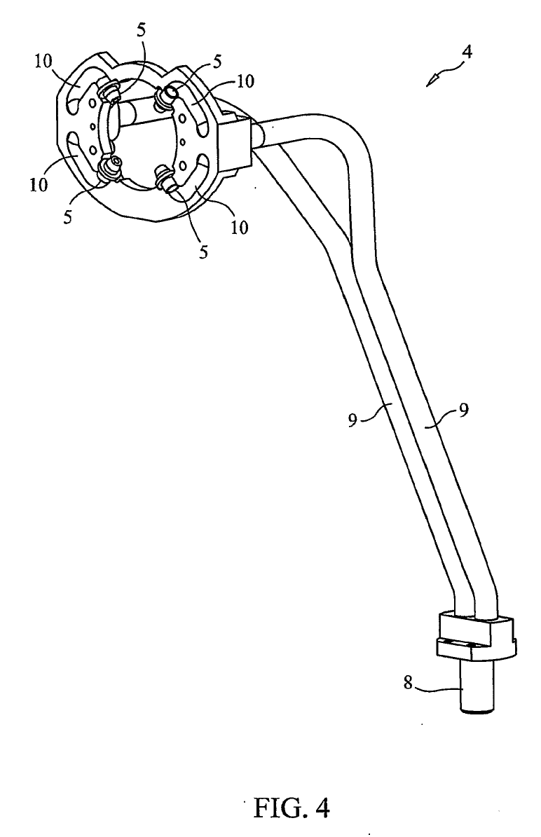

Referring to FIG. 4, a preferred embodiment of tubular manifold 4 is presented. In this embodiment, powdered material, entrained in a gas stream, enters tubular manifold 4 through main material transport tube 8. Tube 8 preferably branches into two smaller diameter, primary branch tubes 9. Primary branch tubes 9 preferably branch into four smaller secondary branch tubes 10. Powdered material 11 exits secondary branch tubes 10 at material injectors 5. The purpose of conveying material through successively smaller diameter tubes 8, 9, and 10 is to maintain or slightly increase the velocity of the material as it is conveyed through the branches of tubular manifold 4. By maintaining or slightly increasing the velocity, saltation (i.e., powdered material falling out of the conveying gas stream) is prevented. A more preferred embodiment uses opposing pairs of material injectors 5.

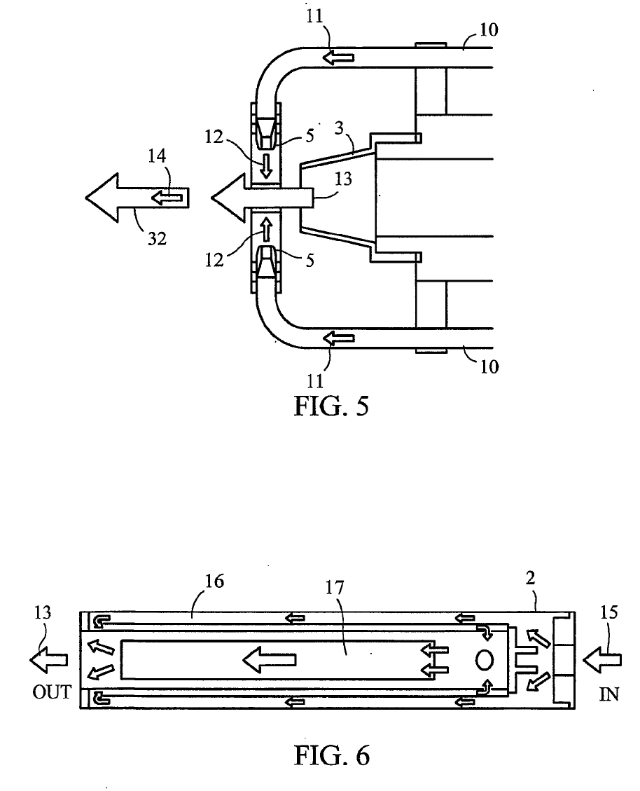

Referring to FIG. 5 a cross-sectional view of the material injection element of a preferred embodiment of the invention is presented. Hot air jet 13 (schematically depicted by an arrow) enters converging nozzle via its inlet and exits converging nozzle 3 via its outlet. Powdered material 11 (schematically depicted by arrows) is conveyed to a plurality of (preferably four) material injectors 5 in secondary branch tubes 10 that produce impinging material 12. Upon exiting material injectors 5, impinging material 12 (schematically depicted by arrows) impinges onto and penetrates into hot air jet 13 adjacent to and outside of the outlet of converging nozzle 3. Impinging material 12 then becomes entrained in convective heat transfer region 14 of spray 32 and melts in flight to substrate 34.

Practicing this preferred embodiment of the invention produces two benefits: (1) fouling is eliminated because powdered material 11 melts outside of applicator head 26 in convective heat transfer region 14 of spray 32; and (2) the efficiency of heat transfer from hot air jet 13 to powdered material 11 is improved which facilitates melting the particulate material in flight. In this embodiment, the opposing streams of impinging material 12 that impinge into and penetrate hot air jet 13 do so in a non co-linear fashion. While FIG. 5 depicts the streams of impinging material 12 preferably impinging at an angle that is substantially normal to the longitudinal axis of hot air jet 13, impinging at other angles is also envisioned.

This impinging action improves the convective heat transfer coefficient thus improving the heat transfer efficiency between hot air jet 13 and powdered material 11. As a particle of powdered material 11 enters hot air jet 13, the particle's velocity in the direction of hot air jet flow is zero. As the particle becomes entrained in hot air jet 13, it is accelerated by hot air jet 13 and the particle's relative velocity begins to increase from zero until it reaches the final velocity of hot air jet 13. A person having skill in the art of forced convection heat transfer would understand that the convective heat transfer coefficient is a function of the relative velocity between the particle and hot air jet 13. In this case the higher the relative velocity, the higher the heat transfer coefficient. So, to maximize heat transfer it is preferred to maximize the relative velocities. Preferred embodiments of the invention accomplish this result.

Referring to FIG. 6, a cross-sectional view of the heating gas flow path within applicator body 2 of a preferred embodiment of the invention is presented. In this embodiment, high volumetric flow air 15 produced by regenerative blower 19 enters applicator body 2 and circulates in serpentine path 16 before entering the section having heater element 17. In a preferred embodiment, heater element 17 is serpentine type VI 6 kW heating element, by Instrumentors Supply Inc., Oregon City, Oreg. Heated air 13 exits the end of the applicator body 2 through convergent nozzle 3.

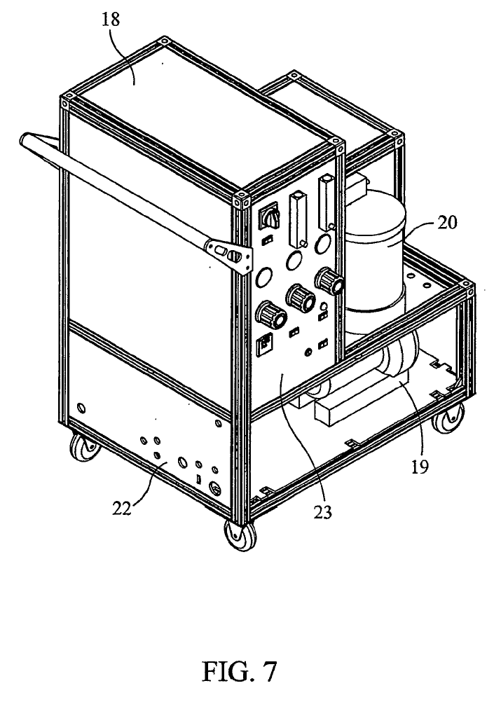

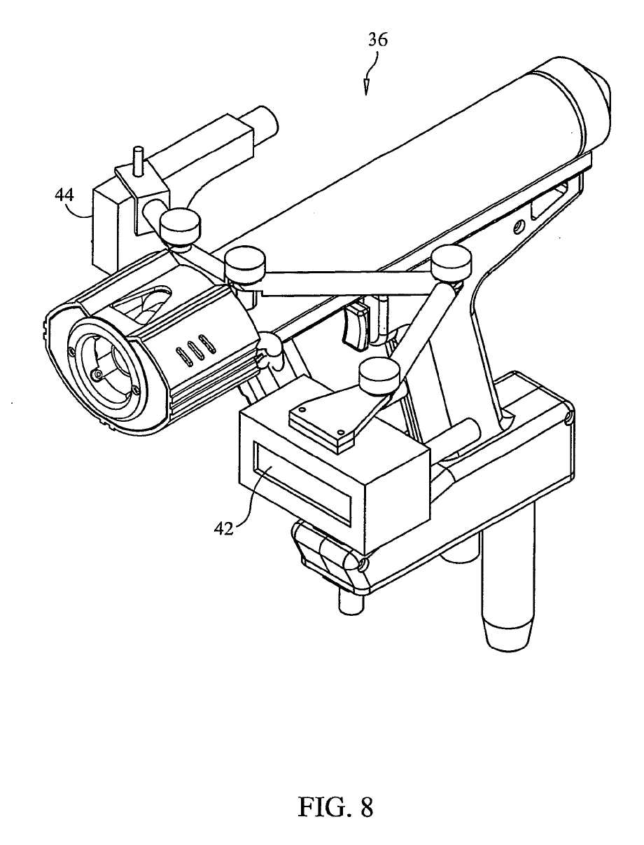

Referring to FIG. 7, support cart 18 of a preferred embodiment of the invention is presented. In this embodiment, regenerative blower 19 supplies air to convective heater 17 in applicator head 36 through umbilical assembly 1 (see FIG. 2) connecting applicator head 36 to cart 18. A manually operated dump valve (not shown) or electrically activated solenoid (not shown) is used to adjust the air supplied to convective heater 17 in applicator head 36, thereby allowing for optimization of various operating and performance parameters (e.g., particle impact velocity, heat transfer efficiency, etc.) required by various polymer materials.

In a preferred embodiment, fluidized bed powder hopper and venturi powder pump 20 is used to store and meter polymer powder 11 for transport to applicator head 36 (see FIG. 2). Rotary compressor 21, such as, Rotary Compressor DT 4.4 by Cascade Machinery & Electric, Inc., Seattle, Wash., supplies air to fluidized bed hopper and venturi powder pump 20 where polymer powder 11 is introduced into the air stream and transported to material injectors 5 of applicator head 36 via umbilical assembly 1. Rotary compressor 21 supplies an adequate amount of air to prevent saltation of the powder during transport. A manually operated dump valve (not shown) equipped with a flow gauge (not shown) and a pressure gauge (not shown) allows the user to adjust the powder transport parameters to prevent saltation and optimize powder injection velocity into hot air jet 13 as it exits applicator head 36. An on-board compressor (not shown) or user supplied compressed air supplies the air required for powder fluidization, venturi feed, and additional transport air needed to prevent saltation of the powder during transport to the applicator. Flow meters, pressure gauges, pressure regulators and throttling valves are manually adjusted by the user to vary the individual air flows allowing for a wide range of powder mass flow rates.

In a preferred embodiment, service panel 22 provides all the necessary electrical (e.g., power, ground, thermocouple data, and control signals) connections (e.g., via wires) and pneumatic (e.g., convective air supply and powder transport) connections to the umbilical connected to the applicator. Electrical enclosure 23 houses the necessary electrical, process controllers, and safety devices used in conjunction with system 30. Power is supplied by the user to cart 18 via a power cable (not shown) and distributed to the various subsystems within enclosure 23. Process temperature settings are controlled with digital temperature controllers (not shown) or a process logic controller.

Referring to FIG. 8, the operational capability of another preferred embodiment of polymer thermal spray system 30 is enhanced by the use of additional radiation source 42. When using UV-light-curable polymer powder, additional radiation source 42 is a UV light source such as an RX Starfire 75 produced by Phoseon Technology, Inc. of Hillsboro Oreg. When using thermosetting polymer powder, additional radiation source 42 is an infrared (IR) heat lamp. When using thermoplastic powders, no additional radiation source is required.

In preferred embodiments, a factor relied on in control of the process is the distance from material injectors 5 to target substrate 34. This distance is maintained by the use of laser distance gage 44, such as LaserPaint™ gage produced by IWRC of Cedar Falls, Iowa.

In this embodiment, laser distance gage 44 allows the operator to establish and maintain material injectors 5 at a desired distance from substrate 34. This operating parameter is preferably controlled to optimize heat transfer as well as particle deposition quality and shape, and ultimately the coating thickness, quality and curing. Control of this parameter is important with some cure-sensitive coatings. Incorporation of laser distance gage 44 into system 30 reduces the necessary skill/training level of the person applying the coating. In a preferred embodiment, the distance from substrate 34 maintained by means of laser distance gage 44 is adjustable to accommodate different coating requirements and materials, as well as different coating thicknesses and curing conditions, e.g., level of heat, etc. The laser distance gage provides a visual indicator to the operator which in turn enables the operator to maintain a desired working distance.

In preferred embodiments, the disclosed system and process allow for the on-site application of high performance polymer coatings on a wide variety of substrate materials, including metal, polymer, wood and paper. Preferably, the disclosed system and process provide a self contained, mobile device for use in constrained spaces, remote locations and manufacturing operations.

Operation of preferred embodiments of the invention involves plugging the power cable from cart 180 into a 208/240 volt service outlet. In another step, the main cart power switch is turned on. Next, polymer powder 11 is loaded into fluidized bed hopper and pump 20. Then, rotary compressor 21 is turned on which provides the flow and pressure controls for the fluidized bed, the powder pump transport air and the powder pump atomization air. In another step, regenerative blower 19 and the convection air flow rate is adjusted. Then, the temperature controller is turned on and the hot air temperature is adjusted. In another step, the user directs the hot air stream at the substrate to be coated. Then, the user pulls trigger 6 to initiate material flow. In another step, the user sweeps the surface of substrate 34 with steady, overlapping strokes to apply a uniform coating of polymer. When the coating operation is complete, the user turns off the temperature controller. After about five minutes, the user turns off regenerative blower 19 that had been providing the convective heating air. Then, the user turns off rotary compressor 21 that had been providing the material transport air.

Another preferred embodiment incorporates tribocharging and positive or negative charge enhancement of the particles of polymer powder 11 to improve the transfer efficiency to the applied polymer coating. In another preferred embodiment, an electrostatics approach is used to improve polymer spray distribution and transfer efficiency to the substrate.

In a preferred embodiment, an electrode that is charged with a high voltage (e.g., 40,000 volts) is disposed internally to applicator head 36, and external to but near the exit of converging nozzle 3. This electrode provides a charged field within which the particles of moving polymer powder 11 pick up a negative charge or a positive charge. A person having skill in the art would understand that this is a common feature of conventional powder spray guns, but not thermal spray guns.

In another preferred embodiment, an electrostatic spray application approach is incorporated into the methods disclosed herein. In this embodiment, a fluidized bed is created in the feed hopper that holds polymer powder 11. This fluidizes polymer powder 11 so that it can be pumped to the tip of a spray gun using compressed air for transport from the feed hopper to the gun tip. The spray gun is designed to impart an electrostatic charge to powder material 11 and direct it toward grounded substrate 34 (e.g., a workpiece). This approach makes it possible to apply much thinner coatings with a wide variety of decorative and protective features.

The electrostatic charge may be imparted to the particles of polymer powder 11 by imposing a voltage, called corona charging, or by frictional contact with the inside of the gun barrel, called tribocharging. In a corona charging system, a voltage source supplies electrical current through a voltage cable to the powder gun tip. Polymer powder 11 is pumped through the gun and out of the gun tip using compressed air. As polymer powder 11 passes through the electrostatic field at the gun tip, it picks up a charge and is attracted to the grounded workpiece. The workpiece is then conveyed to an oven for curing of the powder. In the cure oven, polymer powder 11 melts and cross-links to produce a hard film that completes the process.

Preferred embodiments of the invention operate advantageously to heat materials (in particular, polymeric materials) as they are fed into a hot gas stream. In these embodiments, the cold particles are injected at a high angle, preferably substantially perpendicular to the direction of the hot gas flow stream, or even upstream of the formation of the stream. The particles experience a high rate of heat transfer due to the difference in velocity of the particle compared to that of the gas stream (which produces a high convective heat transfer coefficient) and then are carried with the gas stream toward the target. As the particle-laden gas stream approaches the target, cool air from the surrounding air is entrained into the gas stream. However, the particle can remain heated (melted) because the particle velocity approaches the gas velocity, and the to heat transfer from the particle back to the, now cooler, gas is low because the difference in velocity between the particles and gas stream is low, and the heat transfer coefficient is low.

The molten (heated) particle impacts the target substrate and adheres to it. However, the gas steam temperature is now low, because it has been cooled by dilution with ambient air, and this allows the operator to coat low temperature surfaces, e.g., paper, plastic, electronics, aluminum, composites, etc.

Preferably, in operating system 30, the operator balances the initial hot air temperature, particle size, particle melting temperature, mass of hot air, hot air plume geometry, velocity of particle impingement to get into the hot core, particle loading, etc. The total mass relative to the hot gas (total heat capacity and relative temperatures, as well as heat transfer is preferably matched for the particles to be sufficiently heated to melt, yet result in a suitable coating being produced. Operation of system 30 is carried out in such a way as to not overheat the polymeric particles that are being injected into the gas stream.

In preferred embodiments, the operator balances particle/substrate/coating heating (UV-light-curing) to cause the particles to stick to the substrate and to form a coating and/or cure (e.g., thermoplastic, UV-light-cured or thermoset). Another variable is distance of the spray nozzle (actually, plum length and spray velocity) from the surface being sprayed.

Many variations of the invention will occur to those skilled in the art. Some variations include using hot air from the converging nozzle 3 to fuse the deposited molten material into a film on the substrate 34 without adding additional material. Other variations call for provision of two pairs of opposing material injectors 5. All such variations are intended to be within the scope and spirit of the invention.

Although some embodiments are shown to include certain features, the applicants specifically contemplate that any feature disclosed herein may be used together or in combination with any other feature on any embodiment of the invention. It is also contemplated that any feature may be specifically excluded from any embodiment of the invention.

1-35. (canceled)

36. A process for forming a material deposit on a target substrate, the process comprising:
heating a gas flow stream in a thermal spray gun to a temperature between about 100° C. to about 900° C. to produce a heated gas flow stream and projecting the heated gas flow stream toward the target substrate;
injecting a powdered material into the heated gas flow stream through at least two material injectors coupled to the thermal spray gun that are operative to propel the powdered material into the heated gas flow stream at angles that are substantially normal to the heated gas flow stream such that the powdered material at least partially melts within the heated gas flow stream to produce a plurality of heated material particles; and
directing and propelling the heated material particles onto the target substrate.

37. The process of claim 36, wherein the at least two material injectors comprise at least one pair of opposing material injectors.

38. The process of claim 36, wherein the gas flow stream is heated within an applicator body of the thermal spray gun and the powdered material is injected into the heated gas flow stream after the heated gas flow stream is projected from the applicator body towards the substrate.

39. The process of claim 38, wherein the heated gas flow stream is projected out of the applicator body through a converging nozzle.

40. The process of claim 36, wherein the powdered material comprises particles having sizes of between about 30 microns to about 500 microns.

41. The process of claim 36, comprising transporting the powdered material to the at least two material injections through a series of tubes having decreasing diameters.

42. The process of claim 36, wherein heating the gas flow stream comprises flowing the gas flow stream through a serpentine path through a heating element.

43. The process of claim 36, wherein the gas flow stream is heated to about 700° C.

44. The process of claim 36, wherein the gas flow stream is heated to a temperature above the melting point of the powdered material and below a temperature which will cause the powdered material to ignite during deposition.

45. The process of claim 36, comprising ceasing injection of powdered material into the heated gas flow stream while directing the heated gas flow stream towards the substrate to fuse the material deposited on the substrate.

46. The process of claim 36, wherein the material deposit comprises a polymer coating.

47. A process for forming a material deposit on a target substrate, the process comprising:
heating a gas flow stream by flowing it along a serpentine path through a heating element of a thermal spray gun to produce a heated gas flow stream;
projecting the heated gas flow stream out of the thermal spray gun toward the target substrate;
injecting a powdered material into the heated gas flow stream through at least two opposing material injectors that are operative to propel the powdered material into the heated gas flow stream at angles that are substantially normal to the gas flow stream such that the powdered material at least partially melts within the heated gas flow stream to produce a plurality of at least partially melted material droplets; and
directing the plurality of at least partially melted material droplets onto the target substrate.

48. The process of claim 47, wherein the gas flow stream is heated to a temperature of about 100° C. to about 900° C.

49. The process of claim 48, wherein the gas flow stream is heated to a temperature of about 700° C.

50. The process of claim 48, wherein the gas flow stream is heated to a temperature above the melting point of the powdered material and below a temperature which will cause the powdered material to ignite during deposition.

51. The process of claim 47, wherein the at least two opposing material injectors comprise at least one pair of opposing material injectors.

52. The process of claim 47, wherein the gas flow stream is heated within an applicator body of the thermal spray gun and the powdered material is injected into the heated gas flow stream after the heated gas flow stream is projected from the applicator body towards the substrate.

53. The process of claim 52, wherein the heated gas flow stream is projected out of the applicator body through a converging nozzle.

54. The process of claim 47, wherein the powdered material comprises particles having sizes of between about 30 microns to about 500 microns.

55. The process of claim 47, comprising transporting the powdered material to the at least two opposing material injectors through a series of tubes having decreasing diameters.

56. The process of claim 47, comprising ceasing injection of the powdered material into the heated gas flow stream while directing the heated gas flow stream towards the substrate to fuse the material deposited on the substrate.

57. The process of claim 47, wherein the material deposit comprises a polymer coating.

58. A thermal spray gun for forming a material deposit on a target substrate comprising:
an applicator body including a heater configured for heating a gas flow stream to a temperature in the range of about 100° C. to about 900° C. to produce a heated gas flow stream;
a nozzle coupled to a front of the applicator body for projecting the heated gas flow stream out of the applicator body toward the target substrate; and
a manifold including at least two material injectors operative to propel powdered material into the heated gas flow stream at angles that are substantially normal to the heated gas flow stream such that such the powdered material at least partially melts within the heated gas flow stream to produce a plurality of heated material particles.

59. The process of claim 58, wherein the at least two material injectors comprise at least one pair of opposing material injectors.

60. The thermal spray gun of claim 58, wherein the manifold is positioned at a forward end of the applicator body such that the powdered material is injected into the heated gas flow stream after the heated gas flow stream is projected out of the applicator body through the nozzle.

61. The thermal spray gun of claim 58, wherein the nozzle comprises a converging nozzle.

62. The thermal spray gun of claim 61, comprising a thermocouple positioned at about the converging nozzle to measure the temperature of the heated gas flow stream leaving the applicator body.

63. The thermal spray gun of claim 58, wherein the manifold is configured to inject powdered material having particle sizes of between about 30 microns to about 500 microns.

64. The thermal spray gun of claim 58, wherein the material deposit comprises a polymer coating.

65. The thermal spray gun of claim 58, wherein the manifold comprises a series of tubes leading toward the at least two material injectors, and wherein the diameters of the tubes decrease closer to the at least two material injectors.

66. The thermal spray gun of claim 58, wherein the applicator body comprises a serpentine gas flow path through the heater.

67. The thermal spray gun of claim 58, wherein the heater comprises a replaceable heating element.

68. The thermal spray gun of claim 58, wherein the heater comprises an electric in-line heater.
